(19) United States
(12) Patent Application Publication
(10) Pub. No.: US 2008/0256729 A1
(43) Pub. Date: Oct. 23, 2008

(54) Teeth Whitening Toothbrush

(76) Inventor: John Link, Chestnut Ridge, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/737,785

(22) Filed: Apr. 20, 2007

(51) Int. Cl. A46B 15/00; A61C 17/00

(52) U.S. Cl. 15/105; 433/215

(57) ABSTRACT

A toothbrush for enhancing the whiteness of teeth while carrying out normal prophylactic brushing with a material that includes a light/heat activated whitening agent. The whitening agent is usually activated by light of a certain wavelength. The toothbrush comprises a handle and a head and optical transmission material bringing light of a predetermined frequency to the head portion. The head portion has a clear surface into which the bristles are secured so as to cause light to shine on the teeth surfaces as they are being brushed by the bristles.

### BACKGROUND OF THE INVENTION

1. Field of the Invention

This invention relates to a new system and method for providing teeth cleaning and whitening. More particularly, the invention relates to systems and methods for providing a whitening system for home use with the convenience of brushing and cleaning your teeth, simultaneously.

2. General Background and State of the Art

Many people would like to have a clean, bright white smile. Stained or yellow teeth by food, coffee or tobacco is unappealing and in some instances not healthy. Use of the whitening toothbrush on a daily basis will safely eliminate these stains and maintain a bright, clean, healthy smile between regular visits to your dentist. Current whitening systems require the use of trays, harsh chemicals or strips to be placed directly on the teeth in order to maintain or whiten. These methods are both time consuming and expensive if performed in the dentist's office. Thus, there has been a need for a whitening toothbrush used in conjunction with a whitening agent contained in the cleaning paste itself.

### SUMMARY OF THE INVENTION

Therefore, it is an object of the present invention to provide an easy, cost effective way of maintaining a clean, white smile on a daily basis. It is further an object of the present invention to provide a whitening system that utilizes conventional whitening pastes, gels, or bleach, enhanced and accelerated by utilizing a direct light source and or heat derived from this light source, ultimately being projected from the head of the brush, to clean and whiten teeth.

One exemplary embodiment of the present invention includes the use of available, over the counter agents used to whiten teeth. Some of these agents may contain, but are not limited to: bleach or carbamide peroxide based gels or pastes. These products will be further activated by the light emanating from the clear toothbrush head or through the use of fiber optics or low heat which is also generated by the light source.

In another exemplary embodiment of the present invention, the light itself may be used to locate problem areas, discoloration or cavities inside the mouth by illuminating the head of the brush. Or as a novelty item in which the head of the brush illuminates with a single or multi colored pattern to enhance and entertain children while brushing their teeth.

In another exemplary embodiment of the present invention, the brush may consist of a small motor to power the bristles in such a fashion as an electric toothbrush. The combination of power driven bristles, light source, and or heat will provide optimal cleaning and whitening characteristics.

In yet another exemplary embodiment of the present invention, the brush may be powered by either standard alkaline batteries or by utilizing rechargeable, self contained batteries or standard household AC current with an adapter.

The removable head may be replaced when the bristles wear or should the light source deplete or burn out over time. These heads may also be purchased individually as needed.

The brush head can include small, removable rings of varying colors in order to distinguish one brush from another. The heads themselves may be of varying colors for this distinction as well.

This brush has whitening effects when used in conjunction with whitening agents. However, an advantage of this brush is that it is also effective when used as a standard toothbrush, with ordinary pastes or gels for cleaning teeth.

Other embodiments of the present invention utilize variations of lighting sources to accommodate different types of whitening pastes or gels. These variations may include but are not limited to: Gas plasma light/light emitting diode, metal halide light, Biolase laser, halogen light, or plasma arc light.

Another embodiment of the present invention transfers light from a source remote from the brush head to the head by utilizing fiber optic channels, such as, by way of example, but not limited to; DeSolite or Cablelite fiber optic materials.

Yet another embodiment is to have the light source mounted directly, by way of example, behind the bristles in the head of the brush itself.

A source of heat, including by way of example only, radiant heat from the light source itself, which may also emit a low heat, is useful to activate or enhance the performance of some types of pastes or gels. The heat in conjunction with the light will enable the invention to achieve whitening with either light sensitive or heat sensitive pastes, gels or bleach, or the combination of heat and light is often synergistic.

The body of the brush itself, most notably the handle, can be coated in whole or in part by rubber for ease and comfort of grip. The head can consist of a solid color with exception to the base where the bristles are connected. This area will remain clear enabling the light to be radiated from the brush head into the mouth and teeth area.

Another embodiment of the present invention is to locate the light source in the shaft or handle leading to the bristles. This light would then be set to project its light along an optical path in the shaft to the brush head and then down along the bristles and/or through the bristles to the surface of the teeth. Light can radiate from a source exterior of the brush, through fiber optic material into the head and forward towards the bristles and into the mouth.

### BRIEF DESCRIPTION OF THE DRAWINGS

FIG. 1a illustrates a side view of an exemplary embodiment of the portable whitening toothbrush of the present invention.

FIG. 1b illustrates a cutaway side view of the exemplary embodiment of the teeth whitening apparatus of FIG. 1a.

FIG. 1c is an exploded view of the removable toothbrush head and power connection of the embodiment of the present invention of FIG. 1a.

FIG. 1d is an enlarged front plan view of the toothbrush head (bristles forward facing out from the page) and showing the location of the light emitting surface of the embodiment of the present invention of FIG. 1a.

FIG. 1e illustrates the light source location in the shaft leading to the bristles of the embodiment of the present invention of FIG. 1a.

FIG. 2a is a sectional side view of another embodiment of the present invention showing the light source and the fiber optic material by which light is transferred to the toothbrush head, from which light shines down along the bristles.

FIG. 2b is a sectional side view of another embodiment of the present invention where the bristles themselves are a continuation of the fiber optic material which transfers light from the light source to the brush head.

FIG. 2c is a sectional side view of yet another embodiment of the present invention where the light source is located in the head of the brush directly behind the bristles. The bristles at this point may or may not be of fiber optic materials, such as; DeSolite or Cablelite.

FIG. 2d illustrates the embodiment of FIG. 2c where DeSolite or Cablelite bristles are protruding from the brush head (bristles forward) In this embodiment of the present invention the fiber optic bristles are also used to transfer the light/heat from the light source directly through the brush head onto the teeth surfaces.

FIG. 3 is a sectional side view of another embodiment of the present invention showing the light source externally of the toothbrush and a fiber optic material cable connected to one end of the toothbrush, by which light is transferred to the toothbrush head, from which light shines down along the bristles.

### DETAILED DESCRIPTION OF THE INVENTION

In the following description of the preferred embodiments reference is made to the accompanying drawings which form a part thereof, and which are shown by way of illustrating specific embodiments in which the invention may be practiced. It is to be understood that other embodiments may be utilized and structural and functional changes may be made without departing from the scope of the present invention.

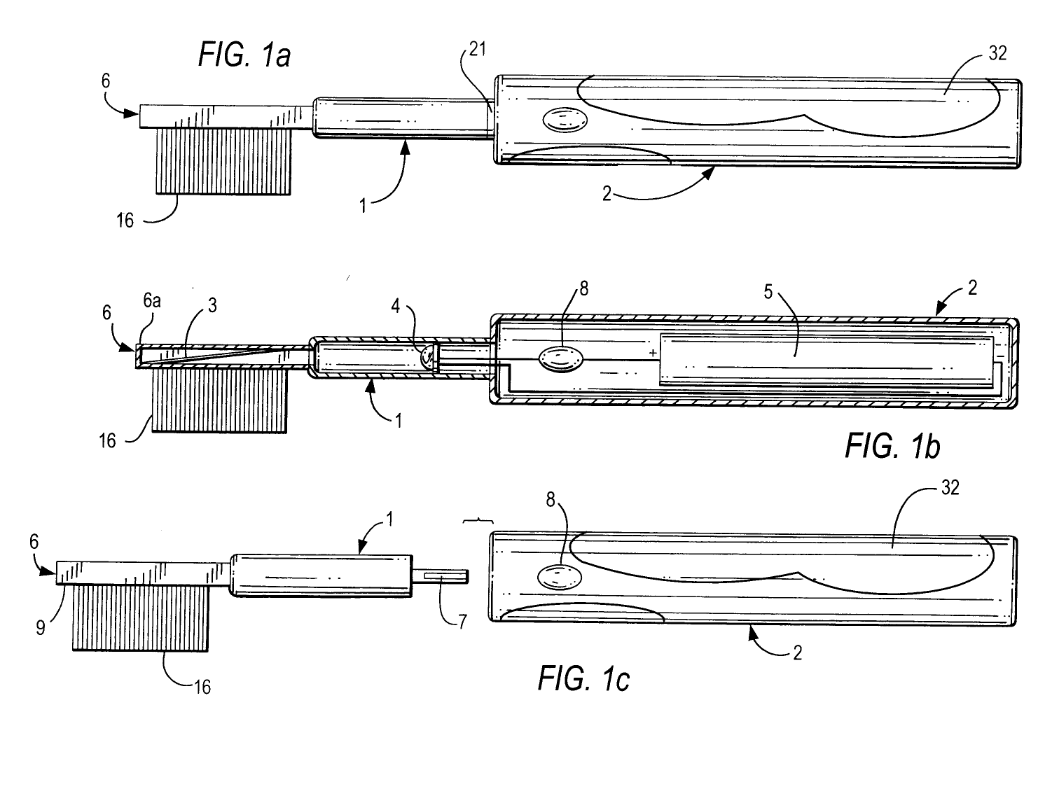

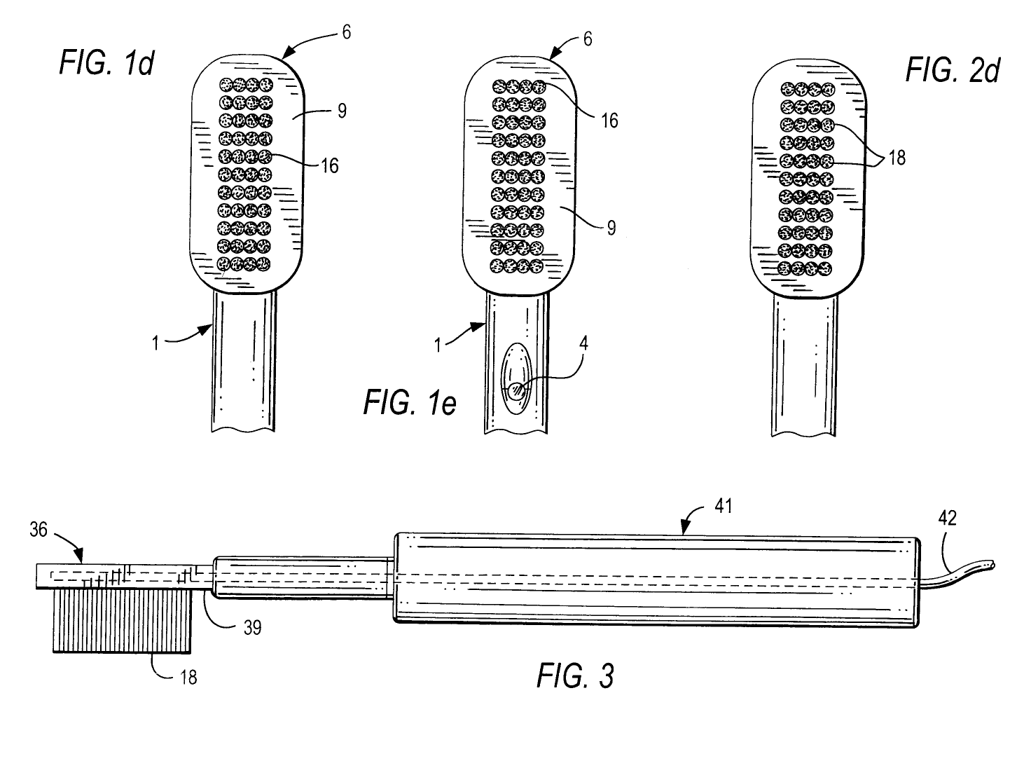

A side view of the whitening toothbrush of the present invention is depicted in FIG. 1a, and another side view cutaway depicting the working parts in FIG. 1b. FIG. 1c demonstrates the two sections which when combined encompass the embodiment of the present invention. FIGS. 1d and 1e both represent a close-up of the toothbrush head 6 (bristles 16 facing outward) and indicate the location of the light source(s) 4 (in the shaft 1) of this embodiment of the present invention. Preferably, in this embodiment, the shaft 1 has an internally mirrored surface to channel light from the light source 4 to the reflecting surface 3 in the head. The top surface 6a of the head 1 also preferably has an internally mirrored surface. FIG. 2a is a diagrammatic cutaway view of another embodiment of this invention which includes a fiber optic cable extending from a light source to the head of the toothbrush, showing the use of fiber optics within the toothbrush to channel the light from the light source 4 to the bristles 16. FIG. 2b shows another embodiment by a diagrammatic cut-away view where the individual strands of the optical fiber cable extend at least part way along the bristles, out from the head, alongside (or through) the bristles 14 themselves, which thus can be a continuation of the fiber optic material. FIG. 2c is a diagrammatic cutaway view of another embodiment of the invention, where the location of the light source 13 is located in the head 36 of the brush, directly behind the bristles; the base 9 of the head is clear, to allow light to shine through. FIG. 2d is a vertical plan view of the brush head, showing the use of fiber optic transmitting bristles to transfer light and, in some cases, heat, directly from the light source. It is often desirable to avoid heating the teeth surface while brushing, and in those cases, preferably a cool blue light can be used, which has little or no infra-red component.

In one embodiment, FIG. 1a depicts an interchangeable ring 21, which can be attached to distinguish one toothbrush from another; these color coded rings can be removed and changed as needed. The handle 2 present invention, in some embodiments, can be rubber coated in whole or in part 32 to ensure ease of grip and a non-slip surface.

The exploded view of FIG. 1c depicts the two sections of this embodiment of the present invention. The removable head consists of the bristles and clear base 6, from which the bristles extend; which allows the light to pass through and onto the teeth. The light source 4 may also be contained in the brush head, as shown in FIG. 2c, which can be connected to the power supply 5 via the connector pins, consisting of two metal contacts 7. The positive (+) and negative (−) connectors 7 when pressed into the base, make contact with the battery 5, through switch 8, providing power when the switch 8 is in the “on” position.

The magnified front plan view of FIG. 1d shows the location of the light emitting surface 9 of the head, in relation to the bristles. The light not only will emit from the area surrounding the bristles but may also emit from beneath the clear bristles themselves.

The close-up view of FIG. 1e of this embodiment of the present invention demonstrates the location of the light emitting source 10 placed in the shaft of the brush pointing forward. This light will shine onto and around the brush head including the area where the brush comes in contact with the teeth As shown in FIGS. 2a-b, there may also be optical fibers 11 located between the light source and the brush head and bristles.

The sectioned view of FIG. 2a demonstrates the use of a preferred embodiment including fiber optic materials 11, such as, but not limited to; DeSolite or Cablelite, to transfer light from the light source 4 forward to the head of the toothbrush.

The sectioned diagrammatic view of FIG. 2b demonstrates the use of fiber optic materials 12, such as but not limited to; DeSolite or Cablelite, to transfer the light source forward to the head. In this embodiment, at least some of the bristles themselves are a continuation of individual optical fibers from the cable 11. When used in this fashion the light is applied directly to the teeth via the optic fiber material.

The embodiment of the present invention shown by the cut away view of FIG. 2c demonstrates the placing of the light source 13, for example, but not limited to; Gas plasma light/light emitting diode of a desired wavelength, metal halide light, Biolase laser, halogen light, or plasma arc directly, in the brush head, behind the bristles. This embodiment will eliminate the use of fiber optic or reflective material to channel the light down the shaft to the bristles and or head of the brush. The use of material having optical transmission properties similar to DeSolite or Cablelite fiber optic material may however, be used alongside of or as part of the bristles themselves, to accomplish a better light-to-teeth distribution and concentration; preferably, the optical fiber is interspersed among the bristles, extending from the head, towards the teeth. The fiber optic material may be in the form of a cable, of relatively thinner diameter than the material of the toothbrush handle and neck, and disposed and configured, as is well known, to transmit the light from the source, and to shine the light on the teeth while brushing. A preferred embodiment includes the use of a light emitting diode of a desired wavelength, such as blue light or a red light, located in the brush head. This blue light is especially useful if it is desired to avoid heating the teeth surface.

The close up view FIG. 2d demonstrates a frontal view (bristles forward) and indicates the DeSolite or Cablelite fiber optic bristles 14 protruding from the head. These fiber optic bristles would then be used to apply the light (and optionally heat), as well as the paste, gel or bleach, directly onto the teeth simultaneously, via these bristles.

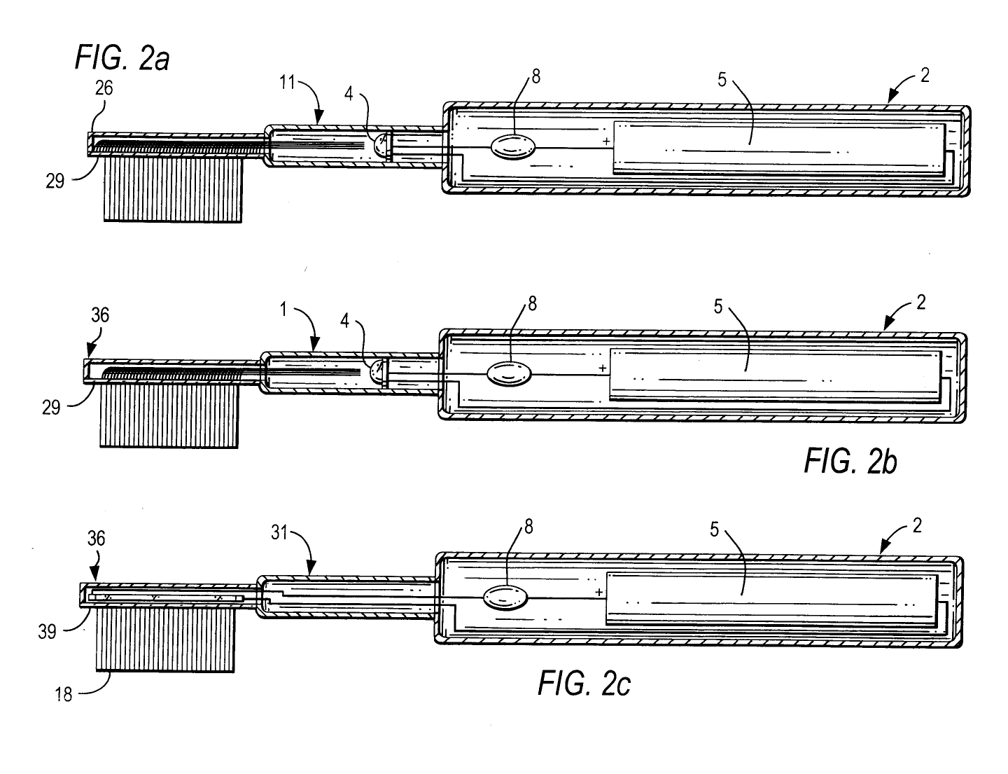

The diagrammatic view of FIG. 3 demonstrates the use of an external light source, containing any of the known sources of suitable frequency light, connected by a fiber optic material cable 42, to transfer the light from the external source forward to the head 36 of the toothbrush. The cable 42 can, preferably, enter the toothbrush handle 41 at the far end, extend through the handle 41 through the neck portion 43 and into the toothbrush head 36. The cable can contain fiber optic material such as, but not limited to; DeSolite or Cablelite. In this embodiment, at least some of the bristles themselves can be a continuation of individual optical fibers from the cable 42. When the fiber optic material extends into or along the bristles, the light is applied directly to the teeth via the optic fiber material. Alternatively, as in FIG. 2A, the light can be directed from the optical fiber strands 42 in the head 36 out through a transparent lower surface 39 of the head.

It should be noted that the whitening toothbrush apparatus of the present invention can also be used as a standard toothbrush when not used in conjunction with whitening pastes, gels or other liquids designed to whiten teeth.

The foregoing description of the preferred embodiments of the invention has been presented for the purpose of illustration and description. It is not intended to be exhaustive or to limit the invention to the precise form disclosed. Many modifications and variations are possible in light of the above teaching. The whitening toothbrush device of the present invention may also be supplemented by features and other than those described herein. It is intended that the scope of the invention be limited not by this detailed description, but rather by the claims appended hereto.

What is claimed is:

1. A toothbrush for providing whitening of teeth while carrying out normal prophylactic brushing, the toothbrush comprising a handle and a head and optical transmission material bringing light of a predetermined frequency to the head portion. The head portion having a clear surface into which the bristles are secured so as to cause light to shine on the teeth surfaces as they are being brushed by the bristles, wherein the usual tooth cleanser material also includes a whitening agent activated by light of a certain wavelength.

2. The toothbrush of claim 1 wherein a light source is located within the toothbrush handle and optical transmission material extends from the light source to the head of the toothbrush.

3. The toothbrush of claim 2 wherein the optical transmission material is an optical fiber and the optical fiber cable extends through the surface of the head and extends at least partway alongside of individual bristles.

4. The toothbrush of claim 1 wherein the optical transmission material extending through the handle through the head is cable having multiple strands and wherein an individual strands of the cable extend adjacent a plurality of bristles extending transversely from the head portion.

5. The toothbrush of claim 1 wherein a light source is located within the head, to radiate light onto teeth being brushed by the bristles

6. A toothbrush having a handle and a head connected to the handle, and bristles extending transversely from the head portion, the improvement comprising an optical transmission material extending longitudinally through at least a portion of the head for carrying light from a light source of a predetermined frequency to the head for transmission onto the teeth surface as it is brushed by the bristles.

7. The toothbrush of claim 5 wherein the light source is located externally of the brush and is connected to the brush by a flexible optical cable.

8. The toothbrush of claim 6 wherein the flexible optical cable is connected to the end of the handle distal from the head, and extends through the handle and into the head.

9. The toothbrush of claim 6 wherein the flexible optical cable comprises a cable formed of multiple optical transmission strands and wherein the strands separate in the head portion of the brush and extend at least partially along the individual bristles.

10. A method of whitening teeth which can be carried out by an individual at home comprising applying a tooth whitening material to the teeth when brushing the teeth for normal prophylactic reasons and utilizing a toothbrush comprising a handle portion, a head portion and bristles extending from the head portion, and optical transmission material extending through the head portion, from a light source of a predetermined frequency which will activate whitening material on the teeth.

11. The method of claim 10 wherein the light source radiates blue light and wherein the whitening material is activated by that frequency of blue light.

12. The method of claim 10 wherein the whitening material is compounded as part of toothpaste and is applied when brushing the teeth for normal prophylactic reasons while passing light of the predetermined frequency through the optical transmission material onto the tooth surface.
